(19) United States
(12) Patent Application Publication
(10) Pub. No.: US 2008/0213499 A1
(43) Pub. Date: Sep. 4, 2008

(54) Electrostatic Coating Spray Gun and Electrostatic Coating Method

(76) Inventors: Takuya Matsumoto, Yokohama (JP); Yasuhiro Ochii, Yokohama (JP); Masanori Takechi, Yokohama (JP)

Correspondence Address: WENDEROTH, LIND & PONACK, L.L.P., 2033 K STREET N. W., SUITE 800, WASHINGTON, DC, 20006-1021, US

(21) Appl. No.: 11/659,714

(22) PCT Filed: Aug. 10, 2005
(86) PCT No.: PCT/JP2005/014971

§ 371 Date: Sep. 11, 2007

(30) Foreign Application Priority Data
Aug. 11, 2004 (JP) 2004-234040

(51) Int. Cl. B05B 5/025

(52) U.S. Cl. 427/483; 118/626

(57) ABSTRACT

When conductive paint is coated by electrostatic coating, the electrostatic charging has many problems. The external electrode is prevailingly used in most of the electrostatic coating spray guns but has many problems in operability, safety, practical usability, etc. when the guns are designed compact. The electrostatic coating spray guns need to be improved in operability, safer with electrostatic charging at a lower voltage, and smaller in structure. To solve such problems, there is provided an improved electrostatic coating spray gun (1) in which an atomizer (2) is provided at the front end thereof to atomize paint jet from a paint nozzle (25) disposed at the center of the atomizer (2) and electrostatically charge the atomized paint particles at a high voltage for attraction to an object to be coated, set at ground potential, charging electrodes (6) as external electrodes are provided on the inner front surface of an air cap (20) or the inner surface of the air cap (20) and a compressed air passage is formed between a paint jet port (26) at the ground potential and the charging electrodes (6). At charging, compressed air prevents discharge from the charging electrodes toward the paint at the ground potential to efficiently ensure ionizing discharge with necessary potential being retained at the charging electrodes (6) and effective charging of paint particles. Since voltage drop is thus prevented, a lower voltage may be used for necessary charging of the paint particles.

### TECHNICAL FIELD

The present invention relates to a hand-held type general-purpose electrostatic coating spray gun and electrostatic coating method suitable for use in electrostatically coating highly conductive paint such as waterborne paint or the like.

### BACKGROUND ART

Being advantageous in the improved efficiency of paint adhesion, saving of resources, reduced environmental pollution, etc, the electrostatic coating method has been used since a long time ago. The methods of electrostatically charging paint at a high voltage for promoting the adhesion of the paint to an object are broadly classified into direct charging and indirect charging. With the direct charging, the paint is electrostatically charged at a high voltage. Thus, the direct charging has often been used with paints of which the electrical resistance is high. In case paint for coating is a conductive one represented by waterborne paint, however, the high-voltage static electricity charged on the paint particles will flow through the paint to a source of the paint so that a high voltage necessary for the charging cannot be retained at charging electrodes. Thus, the entire paint supply system should electrically be insulated from the ground potential to retain the high voltage at the charging electrodes. Namely, many industrial problems remain unsolved.

On the other hand, the indirect charging is such that sprayed paint particles are charged by discharge from charging electrodes provided apart from the paint supply system. The charging electrodes are generally disposed outside the spray gun. Therefore, the paint can electrostatically be charged at a high voltage independently of the conductivity of the paint. For reducing volatile organic compounds to meet the recent requirement for improvement and maintenance of the global environment, importance is given to this indirect charging as an electrostatic coating method used with waterborne paint.

Generally in the indirect charging, the paint side is taken as a ground potential while the charging electrodes provided outside the spray gun are taken as external electrodes, which is called “external electrodes and external charging” (as in the Japanese Published Unexamined Patent Application No. 2004-148239 etc.). In this example, each of the electrodes provided outside the spray gun is designed compact for improved operability of the spray gun, which however is not sufficient as the case may be. Thus, the indirect charging should further be improved. There has been proposed another indirect charging method in which the paint particles are electrostatically charged primarily by ionized air (as in the Japanese Published Unexamined Patent Application No. 2003-236415 etc.) so that this method may not be regarded as satisfactory because of its limits in charging of the paint and forming of electric field on an object to be coated.

Also, there has been proposed a technique of electrostatically coating an object with low-resistance paint with charging electrodes being provided apart from a paint passage on the basis of the concept of the external electrodes (as partially disclosed by way of example in the Japanese Published Unexamined Patent Application H09-047695). In case this technique is used with conductive paint such as waterborne paint, however, since the electrodes are extremely near each other, direct discharge is made to the paint and thus this technique has a safety problem in the electrostatic coating in which the paint is electrostatically charged at a normal high voltage. Also, the direct discharge will deteriorate the ionization of air, resulting in lower charging of the paint particles. Namely, this technique is not adoptable in practice.

Discharge from the charging electrodes to the ground potential (grounding electrode) varies depending upon the distance between both the electrodes and shape of the latter. Generally, when the electrodes are closer to each other, the discharge such as glow discharge or sparking will take place at a lower voltage. In the electrostatic coating, such discharge should strictly be prevented because it is likely to induce danger of ignition or explosion and lower the efficiency of air ionization. On this account, it has been proposed to define a high-ionization zone between the charging and grounding electrodes placed opposite to each other to electrostatically charge sprayed paint particles and there have been studied various conditions such as an optimum charging voltage, structure of each electrode and geometry of the electrodes opposite to each other as will allow the sprayed paint particles to pass through the high-ionization zone for a higher efficiency of electrostatic charging.

Generally in the conventional direct-charging type spray gun in which static electricity is discharged to a grounded part of the spray-gun handle, apart from the ionization zone for assuring the safety, the paint particles are electrostatically charged at a high voltage ranging from 50 to 60 kV. Normally in the spray gun with external charging electrodes, the charging voltage is higher because the high-ionization zone is apart from the sprayed paint particles. Also, in the method in which the ionized air is blown to the external electrodes, the ionized air will be dispersed before the sprayed paint particles are electrostatically charged and thus the air flow be dispersed when the paint is sprayed, which leads to a lower efficiency of electrostatic charging of the paint or paint particles. However, this method is advantageously safe although the safety may not be said to be enough against the electrostatic charging at a high voltage.

### DISCLOSURE OF THE INVENTION

The highly-conductive paint has many problems when it is used for electrostatic coating. The external electrodes are used in most of the electrostatic coating spray guns but have many practical problems in operability, safety, etc. when the spray guns are designed compact. It is required that the electrostatic coating spray guns should be higher in operability, safer with a low voltage for electrostatic charging, and smaller in structure.

Accordingly, the present invention has an object to overcome the above-mentioned drawbacks of the related art by providing an electrostatic coating spray gun usable in electrostatically coating highly-conductive paint such as waterborne paint and which is easier to operate by the painter, more compact and lightweight and operable with a higher safety. The present invention has another object to optimize the conditions under which the charging electrodes are provided and the charging electrodes for making more effective electrostatic coating at a voltage considerably lower than ever, saving resources and reducing environmental pollution.

Normally in the electrostatic paint coating, the higher the charging voltage, the higher the efficiency of paint adhesion to an object to be coated. Since a higher charging voltage will the coating work with the conventional spray gun correspondingly more dangerous, the charging voltage has been specified in the aforementioned industrial range in which it would not be so dangerous to the painter. With the use of a lower voltage for charging the paint, the spray gun can be used with a considerably elevated safety against the high voltage and also the high-voltage generator can be designed more compact and lightweight, which will easily contribute to an improved operability of the spray gun. Among others, the easier operability is essential to the painter. Namely, according to the present invention, there is provided an electrostatic coating spray gun capable of electrostatically charging paint at a lower charging voltage for a required efficiency of coating, which leads to many advantages.

According to an embodiment of the present invention, there is provided an electrostatic coating spray gun including an atomizer provided at the front end thereof to atomize paint jetted from a paint nozzle disposed at the center of the atomizer and electrostatically charge the atomized paint particles at a high voltage for attraction to an object to be coated, wherein:

the paint jetted from the center of the atomizer is connected to a ground potential;

a compressed air passage is provided outside the paint spray; and

charging electrodes having the tips thereof exposed on the front end or surface of an air cap are provided outside the compressed air passage and connected directly to a high-voltage source,

excessive discharge to the ground potential being limited by an air flow jetted from the compressed air passage.

In the above spray gun, the charging electrodes are located outside a central annular hole formed in the air cap with the tips thereof being exposed on the front surface of the air cap so that the charging electrodes will not block the operation of the spray gun or spraying from the latter. Also, a contact portion is provided on the removable air cap oppositely to an high-voltage output exposed at the front end of the spray gun body, and an electroconductive path is formed between the high-voltage output and charging electrodes to keep the electrical connection and also assure the electrical connection between the high-voltage output in the spray gun body and charging electrodes at the air cap even when the air cap is turned halfway to change the spraying direction from vertical to horizontal.

Also in the above spray gun, the charging electrodes to electrostatically charge the paint particles at a high voltage supplied from the high-voltage source or high-voltage generator are disposed with the compressed air passage being defined between the charging electrodes and paint spray to make electrostatic coating with the high voltage on the charging electrodes being set or adjusted for retention within a range of 5 to 10 kV when the compressed air is jetted from the compressed air passage.

In the electrostatic coating by the spray gun constructed as above, the high voltage applied to the charging electrodes is discharged toward an electrode opposite to the paint spray, that is, the ground potential, but the discharge current is limited by the compressed air jetted from the central annular hole in the air cap so that the voltage at the tips of the charging electrodes (will also be referred to as “electrode-tip voltage” hereunder) can be prevented from being lowered. The discharge current when the compressed air is supplied is about a half of that when no compressed air is supplied. Therefore, even if a lower voltage is set for supply, it is possible to retain a necessary electrode-tip voltage and thus the high-voltage source can be designed more compact and lightweight.

Many experiments made by the Inventors of the present invention revealed that the charged paint particles could effectively be attracted to the object to be coated at a voltage of 5 to 10 kV on the tips of the charging electrodes when electrostatic coating was made with the charging electrodes being disposed in the vicinity of a part to be coated and ionization zone was defined within a safe range. The electrode-tip voltage should preferably be on the order of 7 kV, which permits an optimum electrostatic coating with a small power. Also, even in case a battery is used as the power source, there can be provided an electrostatic coating spray gun that can be used satisfactorily in the field of industry.

### BRIEF DESCRIPTION OF THE DRAWINGS

The foregoing and other features, aspects and advantages of the present invention will become apparent from the following detailed description of embodiments of the present invention when taken in conjunction with the accompanying drawings, in which:

FIG. 1 schematically illustrates the construction of the electrostatic coating spray gun as an embodiment of the present invention.

FIG. 2 is a partially sectional view of the spray gun in FIG. 1, showing the atomizer and charging electrodes provided at the front end of the spray gun.

FIG. 3(a) is a front view of the atomizer in another embodiment of the present invention, similar to the spray gun in FIG. 1 except that the charging electrodes is provided in a position different from that in the spray gun in FIG. 1 and FIG. 3(b) is a fragmentary sectional view of the spray gun in FIG. 3(a).

FIG. 4 graphically illustrates the relation between the voltage applied to the charging electrodes and the voltage at the tips of the charging electrodes.

### BEST MODE FOR CARRYING OUT THE INVENTION

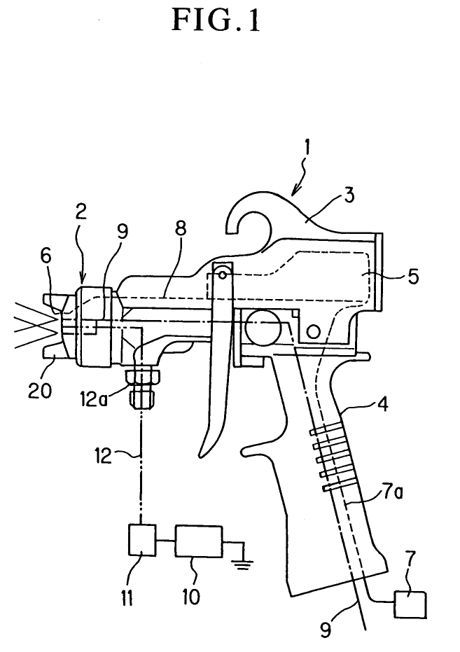

The present invention will be described in detail below concerning a best mode for carrying out the same with reference to the accompanying drawings. FIG. 1 schematically illustrates the hand-held, air atomizing type electrostatic coating spray gun as a whole. The spray gun is generally indicated with a reference numeral 1. As well known with the ordinary electrostatic coating spray gun and as shown in FIG. 1, the electrostatic coating spray gun 1 includes a gun body 3 having an atomizer 2 provided at the front end thereof and a handle 4 extending down and backward from the gun body 3. The gun body 3 is formed form an insulating material, and the handle 4 is formed from an electroconductive material or covered with an electroconductive material, and connected to a ground potential.

According to this embodiment, the gun body 3 has built therein a high-voltage generator 5 of which the output is connected via an interconnecting wire 8 to charging electrodes 6 which will be described in detail later. The high-voltage generator 5 is supplied with a power from an external high-frequency low-voltage source 7 via power cable 7a, to which the present invention is not limited. Also, in the gun body 3, there is formed a compressed air passage 9 extending through the handle 4 to jet a compressed air from an air cap 20 of the atomizer 2. Paint is supplied from a paint container 10 connected to the ground potential through a paint drive 11 and paint passage 12, and sprayed from a paint nozzle 25. The spray gun further includes a trigger, regulator, etc. for paint spray, compressed air jetting and charging control to control the paint spraying. Such construction of the spray gun is well known from many examples and will not be described in detail herein.

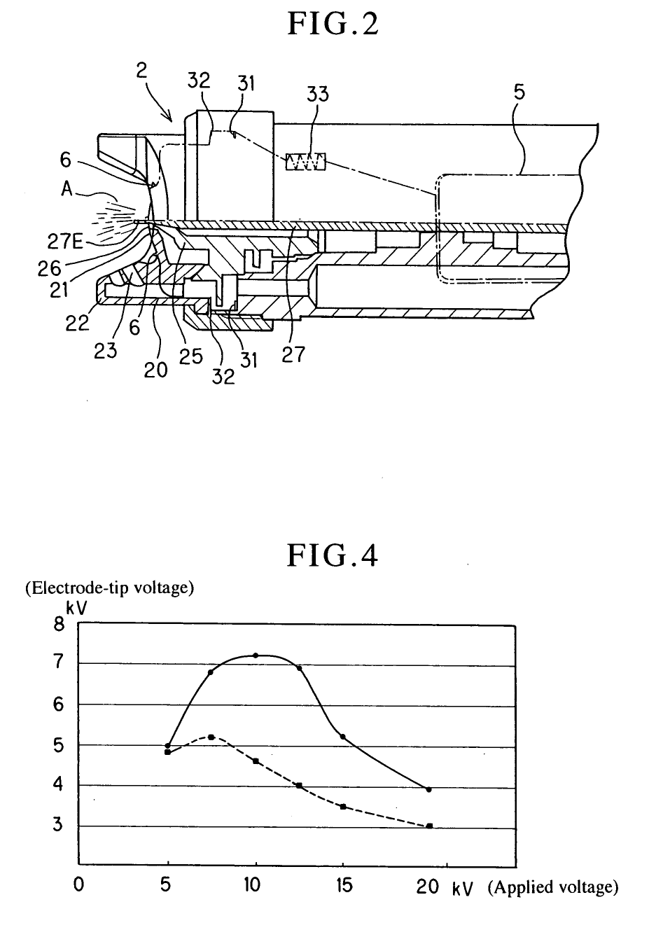

FIG. 2 shows the detail of the atomizer 2 provided at the front end of the spray gun. The atomizer 2 is formed from an insulating material. A paint jet port 26 is formed in the center of the paint nozzle 25 installed to the front end of the gun body 3, and a needle valve 27 to control the start and stop of paint spray is provided in the gun body 3 movably forward and backward. The air cap 20 removably installed before the paint nozzle 25 has a central air port 21 which defines an annular space around the paint jet port 26 to provide an atomizing air port, and pattern-forming air ports 23 which jet air inwardly from angular portions 22 opposite to each other and projecting from around the central air port 21. Each of the air ports 23 is supplied with compressed air through the compressed air passage 9 in the gun body 3. The pain jet port 26 in the paint nozzle 25 is supplied with the paint through the paint passage 12. The gun body 3 and paint passage 12 are connected to each other with a paint joint 12a.

The charging electrodes 6 which are to be applied with a high voltage are provided outside the central air port 21 in the front surface of the air cap 20 to have the tips 61 thereof exposed between themselves and pattern-forming air port 23. Each of the charging electrodes 6 includes connecting terminals 31 and charging terminals 32 which are positively put into electrical contact with the output of the high-voltage generator 5 when the air cap 20 is assembled into the gun body 3. In this embodiment, the charging terminals 32 are so resilient as to be displaceable back-and-forth and the connecting terminals 31 are rotatable in such an angular range of more than at least 90 deg. that they can surely be kept in contact with the output of the high-voltage generator 5 even while the air cap 20 is rotated. These terminals 31 and 32 should preferably be designed to have the static capacity thereof reduced. It should be noted however that the connecting terminals 31 may be resilient enough to be displaceable back-and-forth while the charging terminals 32 be rotatable in the range of more than 90 deg. to positively be kept in contact with the output of the high-voltage generator 5.

The ground potential as an electrode opposite to the charging electrodes 6 may be located at the paint jet port 26, the paint passage 12 may be used as the ground potential or the front end of the needle valve 27 or paint jet port 26 in the paint nozzle 25 may be formed from a conductive material and connected to the ground potential. In the embodiment shown in FIG. 2, a metallic wire 27E is installed at the front end of the needle valve 27 to provide a positive ground potential as the electrode opposite to the charging electrodes 6.

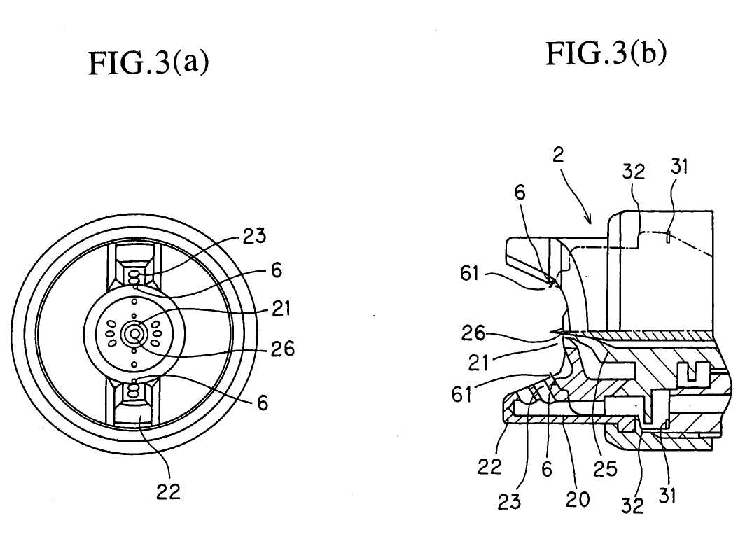

FIG. 3 shows another embodiment of the spray gun according to the present invention. As shown, the charging electrodes 6 are provided on the inner surfaces, respectively, at which the pattern-forming air ports 23 formed in the angular portions 22 of the air cap 20 are open. In any case, the charging electrodes should preferably be provided opposite to each other where the compressed air will be jetted between them and paint jet in the middle of the front opening of the air cap 20. More than one charging electrode 6 provided in positions opposite to each other as shown taking the shape of spray in account can advantageously assure uniform electrostatic charging. Especially, the charging electrodes should preferably be disposed opposite to each other on the inner surfaces, respectively, of the angular portions 22 as shown in FIG. 3(b).

In electrostatic coating, when the trigger is operated, compressed air is jetted from the air cap 20 and then paint is also jetted and atomized for spraying toward an object to be coated. These operations are similar to those of the ordinary air spray gun except that a high-voltage electrostatic charging switch is turned on after the paint spraying, a high voltage is applied from the high-voltage generator 5 to the charging electrodes 6 via a limiting resistor 33, connecting terminals 31 and charging terminals 32 and the voltage is discharged from the tips of the charging electrodes 6 toward the paint jet as the ground potential.

According to the present invention, the high voltage for application to the charging electrodes 6 is adjusted by the limiting resistor 33 for the voltage at the tips of the charging electrodes 6 to be within a range over 5 kV and under 10 kV. That is, as indicated with a dashed line in FIG. 4, as the applied voltage is increased with the inter-electrode distance being 7 mm, the electrode-tip voltage will be increased correspondingly. Just before the applied voltage arrives at 10 kV, the voltage will be discharged. At this time, a large current will flow so that the electrode-tip voltage will be lower and no voltage necessary for ionization can be retained. In FIG. 4, the horizontal axis of the graph indicates the applied voltage while the vertical axis indicates the electrode-tip voltage. In the ordinary electrostatic coating with the air atomization of the paint, the compressed air is jetted so that the compressed air supplied to between the charging electrodes permits to retain the electrode-tip voltage at a level of about 7 kV as shown with a solid line in FIG. 4 because an ionization electrode is provided in the vicinity of the atomization zone to provide an ionization voltage necessary for a higher efficiency of the electrostatic coating, whereby electrostatic coating can effectively be attained with a voltage considerably lower than in the conventional electrostatic coating spray guns.

According to the present invention, the charging electrodes 6 are located near the ground potential to retain the voltage within a range for corona discharge by the charging at a high voltage while reducing the applied voltage for occurrence of no glow discharge. Also, an air flow A compressed to a high density is formed between the charging electrodes 6 and the paint passage at the ground potential, substantially, the metallic wire 27A at the front end of the needle valve 27, to limit unnecessary discharge current to the paint, define a high-ionization zone due to the corona discharge, ionize the compressed air jets one after another and charge the atomized paint as well with minus ions so that the atomized paint can be sprayed toward an object to be coated.

The charging voltage varies depending upon the shape and location of the electrodes. However, it is well known that the discharge current from the electrodes in the electrostatic coating is 10 to 100 μA. When the applied voltage is about 10 kV per 10 mm or higher than 10 kV, glow discharge will normally occur in air, causing a danger such as shock, ignition or the like and also causing a large current which will cause the electrode-tip charging voltage itself to be lower with the result that there will not be assured the electrostatic effect due to the ionization. According to the present invention, charging at a high voltage retained within a range over 5 kV and under 10 kV with jetting of compressed air under a normally used pressure of 100 to 400 kPa from the compressed air passage disposed between the charging electrodes is extremely safe and efficient even though the charging electrodes are disposed near the spraying zone.

1. An electrostatic coating spray gun including an atomizer provided at the front end thereof to atomize paint jetted from a paint nozzle disposed at the center of the atomizer and electrostatically charge the atomized paint particles at a high voltage for attraction to an object to be coated, wherein:
the paint jetted from the center of the atomizer is connected to a ground potential;
a compressed air passage is provided outside the paint spray; and
charging electrodes having the tips thereof exposed on the front end or surface of an air cap are provided outside the compressed air passage and connected directly to a high-voltage source,
excessive discharge to the ground potential being limited by an air flow jetted from the compressed air passage.

2. The electrostatic coating spray gun according to claim 1, wherein the atomizer has the paint nozzle disposed at the center thereof and the air cap having an atomization air port formed at the center thereof is disposed outside the paint nozzle, whereby an annular air hole is defined, and each of the charging electrodes has the tip thereof exposed on the front surface of the air cap and is electrically connected to the output of a high-voltage generator incorporated in the spray gun.

3. The electrostatic coating spray gun according to claim 1, wherein the air cap is designed to removably be installable to the body of the spray gun and at least either of contact portions of the air cap opposite to an high-voltage output exposed at the front end of the gun body is formed in a range of 90 deg. or more to form an electroconductive path between the high-voltage output and charging electrodes.

4. The electrostatic coating spray gun according to claim 1, wherein a plurality of the charging electrodes is disposed opposite to each other about the paint nozzle and each of them is connected directly to a high voltage.

5. An electrostatic coating method in which an atomizer is used to atomize paint jetted from a paint nozzle disposed at the center of the atomizer and the atomized paint particles are electrostatically charged at a high voltage for attraction to an object to be coated, wherein the paint side is connected to a ground potential; and
the charging electrodes to electrostatically charge the paint particles at a high voltage supplied from the high-voltage source are located with the compressed air passage being formed between itself and paint spray to make electrostatic coating with the high voltage on the charging electrodes being set or adjusted for retention within a range of 5 to 10 kV when the compressed air is jetted from the compressed air passage.

6. The electrostatic coating spray gun according to claim 2, wherein a plurality of the charging electrodes is disposed opposite to each other about the paint nozzle and each of them is connected directly to a high voltage.
